(19) United States
(12) Patent Application Publication
(10) Pub. No.: US 2015/0092269 A1
(43) Pub. Date: Apr. 2, 2015

(54) THREE-DIMENSIONAL EYEGLASSES FOR VIEWING 2D IMAGE OR OBJECT IMAGE AS 3D IMAGE

(71) Applicant: Seong-Do KIM, (US)

(72) Inventor: Seong-Do Kim, Seoul (KR)

(21) Appl. No.: 14/387,546

(22) PCT Filed: Mar. 28, 2013
(86) PCT No.: PCT/KR2013/002596

§ 371 Date: Sep. 24, 2014

(30) Foreign Application Priority Data
Mar. 28, 2012 (KR) 10-2012-0031917

(51) Int. Cl. G02B 27/22

(52) U.S. Cl. CPC G02B 27/2221; G02B 27/22
USPC 359/464

(57) ABSTRACT

The present invention relates to three-dimensional eyeglasses for viewing a 2D image or an object image as a 3D image. The three-dimensional eyeglasses (100) for viewing a 2D image (L) as a 3D image of the present invention comprises: a left first reflector (1) which is coupled to the left side of a left eyeglass frame (5) and reflects the 2D image (L); a left second reflector (2) which is coupled to the right side of the left eyeglass frame (5), and which reflects the image reflected from the left first reflector (1) to enable the image to be incident on a left eye (7); a right first reflector (3) which is coupled to the right side of a right eyeglass frame (6) and reflects the 2D image (L); and a right second reflector (4) which is coupled to the left side of the right eyeglass frame (6), and which reflects the image reflected from the right first reflector (3) to enable the image to be incident on a right eye (8), wherein the different images incident on the left/right eye (7, 8) are synthesized in the brain to form a three-dimensional image (3D).

### TECHNICAL FIELD

The present invention is relates to a three-dimensional glasses by that general 2D images can be watched into 3D images. More specifically, 2D video images can be viewed with 3D images without the need for complicated conversion such as the prior art

### DISCUSSION OF RELATED ART

Generally if you want to watch the 3D images from existing 2D images by the present technique, you have to watch left image by left eye and right image by right eye through the way of side by side format after passing the processing for convening the 2D images into 3D images.

Therefore, in order to view a stereoscopic images, you have to take the left and right (L/R) images by the side-by-side manner, or by sequentially recording images of the right and left. And then you have to watch the left images with the left eye, to watch the right images with right eye.

In case of such a conventional technique, in order to view three-dimensional images from the existing 2D image, the complex and difficult process for convening 2D images into 3D images should go through, and then the left images are watched only by the left eye, the right images are watched only by the right eye. So it is a problem that the processing and structure are complicated.

And there is a problem in that the occurrence of the incident light is attenuated and, in that the high-cost production and editing take place, when you watch it through polarization or through the like in the liquid crystal.

On the other hand, there were no existing glasses to make objects look more in three dimensions than seeing general objects with the naked eye.

Considering this point, it is required to develop the three-dimensional glasses to see it in more three-dimensional watching than to see objects with the naked eye.

### PRIOR ART REFERENCES

### Patent Document

Korean Patent Application No. 20-2005-0005838.

### SUMMARY

The purpose of the present invention is to supply 3D glasses that enable you to watch convenient 3D image from existing 2D image without the need for complex transformation such as the prior art, to supply 3D glasses that enable you to watch more effective 3D image from existing objects.

The purpose of above tasks is a three-dimensional glasses (100) that enable you to see 3D image from 2D image (L).

The left first reflector (1) that reflects the 2D image (L), it (1) is coupled to the left of the left-glasses frame (5); The left second reflector (2) is joined to the right side of the left-glasses frame (5).

Into the left eye (7), the left second reflector (2) reflects the reflection image that is reflected by the left first reflector (1).

The left second reflector (2) is the right side from the left first reflecting mirror (1);

The right first mirror (3) that reflects the 2D image (L), it (3) is coupled to the right side of the right frame of glasses (6);

The right second reflector (4) is joined to the left side of the right-glasses frame (6).

Into the right eye (8), the right second reflector (4) reflects the reflection image that is reflected by the right first reflector (3).

The right second reflector (4) is the left side from the right first reflecting mirror (3).

Wherein the different image incident light (L1/L2) on the left and right eyes (7, 8) are composed into 3D image in the brain, which allows distinctively to form a three-dimensional image (3D) to be watched with the 3D image that is achieved by means of a stereoscopic glasses (100).

The left first reflector (1) and the left second reflector (2) of the left-glasses frame (5), also the right first reflector (3) and the right second reflector (4) of the right-glasses frame (6) can be placed side by side to each other.

The purpose of above tasks is also a three-dimensional glasses (200) that enable you to see 3D image from 2D image (L).

The left first reflector (11) that reflects the 2D image (L), it (11) is coupled to the left fourth reflector (14); The left second reflector (12) is joined to the left third reflector (13). The left second reflector (12) again reflects the reflection image that is reflected by the left first reflector (11).

The left third reflector (13) is joined to the right side of the left-glasses frame (55). The left third reflector (13) reflects the reflection image that is reflected by the left second reflector (12).

The left fourth reflector (14) is joined to the left side of the left-glasses frame (55). The loll fourth reflector (14), into the left eye (19), reflects the reflection image that is reflected by the left third reflector (13).

The right first reflector (15) that reflects the 2D image (L), it (15) is coupled to the right fourth reflector (14); The right second reflector (16) is joined to the right third reflector (17). The right second reflector (16) again reflects the reflection image that is reflected by the right first reflector (15).

The right third reflector (17) is joined to the left side of the right-glasses frame (66). The right third reflector (17) reflects the reflection image that is reflected by the right second reflector (16).

The right fourth reflector (18) is joined to the right side of the right-glasses frame (66). The right fourth reflector (18), into the right eye (20), reflects the reflection image that is reflected by the right third reflector (17).

Wherein the different image incident lights (L1/L2) on the left and right eyes (19, 20) are composed into 3D image in the brain, which allows distinctively to form a three-dimensional image (3D) to be watched with the 3D image that is achieved by means of a stereoscopic glasses (200).

The left first reflector (11) and the left second reflector (12) of the left-glasses frame (55), also the right first reflector (15) and the right second reflector (16) of the right-glasses frame (66) can be placed side by side to each other.

And, the left third reflector (13) and the left fourth reflector (14) of the left-glasses frame (55), also the right third reflector (17) and the right fourth reflector (18) of the right-glasses frame (66) can be placed side by side to each other.

By a connecting portion (C), the left second reflector (12) and the left third reflector (13) of the left-glasses frame (55) can be connected to the right second reflector (16) and the right third reflector (17) of the right-glasses frame (66) each other.

The purpose of above tasks is also a three-dimensional glasses (300) that enable you to see more enhanced 3D image than when you see object image (L,R) with the naked eye.

The left first reflector (1′) that reflects the object image (L), it (1′) is coupled to the left of the left-glasses frame (5′);

The left second reflector (2′) is joined to the right side of the left-glasses frame (5′).

Into the left eye (7′), the left second reflector (2′) reflects the object image that is reflected by the left first reflector (1′).

The left second reflector (2′) is the right side from the left first reflecting mirror (1′);

The right first mirror (3′) that reflects the object image (R), it (3′) is coupled to the right side of the right frame of glasses (6′);

The right second reflector (4′) is joined to the left side of the right-glasses frame (6′).

Into the right eye (8′), the right second reflector (4′) reflects the object image that is reflected by the right first reflector (3′).

The right second reflector (4′) is the left side from the right first reflecting mirror (3′).

Wherein the different image incident light (L/R) of the object on the left and right eyes (7′, 8′) are composed into more enhanced 3D image in the brain, which allows distinctively to see more enhanced three-dimensional image (3D) than when you see object image with the naked eye, by means of a stereoscopic glasses (300).

The purpose of above tasks is also a three-dimensional glasses (400) that enable you to see more enhanced 3D image than when you see object image (L,R) with the naked eye.

The left first reflector (11′) that reflects the object image (L), it (11′) is coupled to the left fourth reflector (14′); the left second reflector (12′) is joined to the left third reflector (13′). The left second reflector (12′) again reflects the object image that is reflected by the left first reflector (11′).

The left third reflector (13′) is joined to the right side of the left-glasses frame (55′). The left third reflector (13′) reflects the object image that is reflected by the left second reflector (12′).

The left fourth reflector (14′) is joined to the left side of the left-glasses frame (55′). The left fourth reflector (14′), into the left eye (19′), reflects the object image that is reflected by the left third reflector (13′).

The right first reflector (15′) that reflects the object image (R), it (15′) is coupled to the right fourth reflector (14′); The right second reflector (16′) is joined to the right third reflector (17′). The right second reflector (16′) again reflects the object image that is reflected by the right first reflector (15′).

The right third reflector (17′) is joined to the left side of the right-glasses frame (66′). The right third reflector (17′) reflects the object image that is reflected by the right second reflector (16′).

The right fourth reflector (18′) is joined to the right side of the right-glasses frame right-glasses) (66′). The right fourth reflector (18′), into the right eye (20′), reflects the object image that is reflected by the right third reflector (17′).

Wherein the different image incident lights (L/R) of the object on the left and right eyes (19′, 20′) are composed into more enhanced 3D image in the brain, which allows distinctively to see more enhanced three-dimensional image (3D) than when you see object image with the naked eye, by means of a stereoscopic glasses (400).

The left first reflector (11′) and the left second reflector (12′) of the left-glasses frame (55′), also the right first reflector (15′) and the right second reflector (16′) of the right-glasses frame (66′) can be placed side by side to each other.

And, the left third reflector (13′) and the left fourth reflector (14′) of the left-glasses frame (55′), also the right third reflector (17′) and the right fourth reflector (18′) of the right-glasses frame (66′) can be placed side by side to each other.

By a connecting portion (C′), the left second reflector (12′) and the left third reflector (13′) of the left-glasses frame (55′) can be connected to the right second reflector (16′) and the right third reflector (17′) of the right-glasses frame (66) each other.

On the other hand, the reflector can be replaced by a prism like right angle prism. Furthermore, the lens or filter may be provided in front of the reflector.

In this case, the reflectors that are mounted by connecting type with the lens or the filter can be made more robust to the combination of the entire device. It can provide a corrected visual acuity to the bad visual acuity person. It is possible to obtain the various effects obtained from the general camera according to the characteristics of the filter when you use the filter.

According to the present invention, without the need for complex transformation processes like the prior art, you can see convenient 3D images from 2D image by 3D glasses of the present invention. Therefore, it is capable of watching three-dimensional effect.

Also according to the present invention, without the need for complex transformation processes like the prior art, you can watch more enhanced convenient effective 3D images from object image by 3D glasses of the present invention.

### BRIEF DESCRIPTION OF THE DRAWINGS

FIG. 1 is a structural diagram of three-dimensional glasses, which enable to see 3D image from 2D image according to the first embodiment of the present invention.

FIG. 2 is a structural diagram of three-dimensional glasses, which enable to see 3D image from 2D image according to the second embodiment of the present invention.

FIG. 3 is a structural diagram of three-dimensional glasses, which allow seeing more convenient enhanced effective three-dimensional image (3D) than when you see object image with the naked eye, according to the third embodiment of the present invention.

FIG. 4 is a structural diagram of three-dimensional glasses, which allow seeing more convenient enhanced effective three-dimensional image (3D) than when you see object image with the naked eye, according to the fourth embodiment of the present invention.

### DETAILED DESCRIPTION OF EMBODIMENTS

Hereinafter, a preferred embodiment of the present invention with reference to the accompanying drawings.

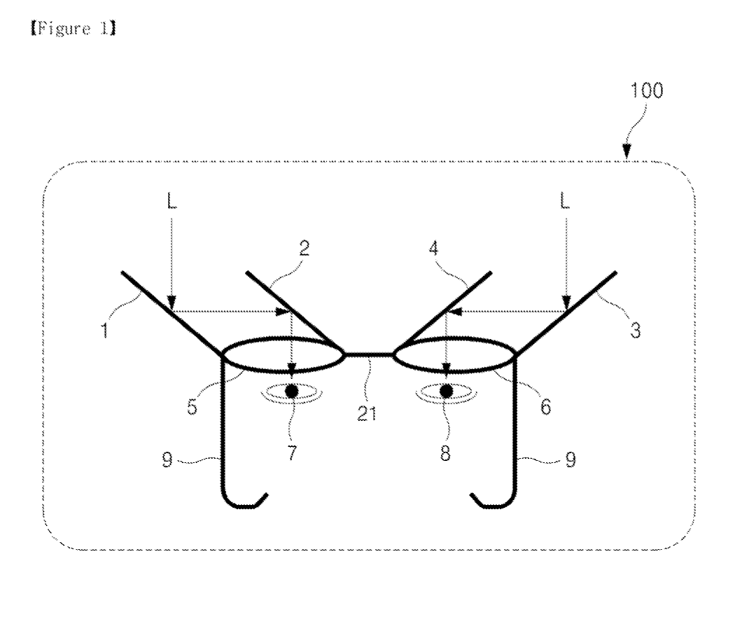

FIG. 1 is a structural diagram of three-dimensional glasses, which enable to see 3D image from 2D image according to the first embodiment of the present invention.

FIG. 1 shows stereoscopic glasses (100) to which the reflectors (1, 2, 3, 4) are attached, enable 2D image (L) to be watched as a three-dimensional image (3D).

According to Stereoscopic eyeglasses (100) of this embodiment includes, the purpose of above tasks is a three-dimensional glasses (100) that enable you to see 3D image from 2D image (L).

The left first reflector (1) that reflects the 2D image (L), it (I) is coupled to the left of the left-glasses frame (5); The left second reflector (2) is joined to the right side of the left-glasses frame (5).

Into the left eye (7), the left second reflector (2) reflects the reflection image that is reflected by the left first reflector (1).

The left second reflector (2) is the right side from the left first reflecting mirror (1);

The right first mirror (3) that reflects the 2D image (L), it (3) is coupled to the right side of the right frame of glasses (6);

The right second reflector (4) is joined to the left side of the right-glasses frame (6).

Into the right eye (8), the right second reflector (4) reflects the reflection image that is reflected by the right first reflector (3).

The right second reflector (4) is the left side from the right first reflecting mirror (3).

2D image (L) that enters into the left eye (07) has an angle of incidence that goes through the left first reflector (1) and the left second reflector (2), and 2D image (L) that enters into the right eye (8) has an angle of incidence that goes through the right first reflector (3) and the right second reflector (4),

So, 2D image (L) data value that enters through the left eye (7) and 2D image (L) data value that enters through right eye (8) is different with each other.

The different image incident light (L1/L2) on the left and right eyes (7, 8) are composed into 3D image in the brain, which allows distinctively to form a three-dimensional image (3D) to be watched with the 3D image that is achieved by means of present invention, a stereoscopic glasses.

That is, since the left eye (7) sees 2D images (L) through the left first reflector (1) and the left second reflector (2), also since right eye (8) sees 2D image (L) through the right first reflector (3) and the right second reflector (4), the parallax takes place on the left eye (7) and right eye (8).

The path of the incident 2D image (L) entering the left and the right eye (7, 8) L/are different. So, the right and left images having a parallax on the left/right eye is produced with a different angle of incidence from each other in the process of being arrived to the left/right eye (7, 8) through the courses of reflectors (1, 2, 3, 4).

Thus, the right and left images having a parallax produced through-three-dimensional glasses (100) of the present invention, is to be incident light to the eyes (7, 8), and then to be formed into a three-dimensional image by being composed in the brain, therefore the two images are produced as 3D images by three-dimensional glasses (100) of the present invention.

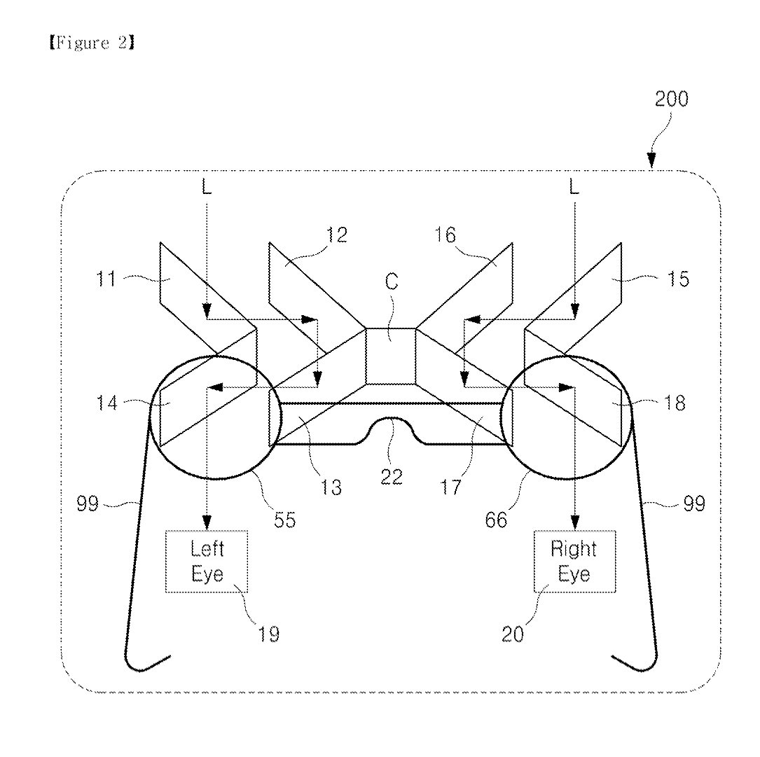

FIG. 2 is according to the second embodiment of the present invention that allows 2D images to be viewed into 3D images.

Referring to the embodiment of this drawings.

The purpose of above embodiment enables you to see 3D image from 2D image (L) through a 3D glasses (200).

The left first reflector (11) that reflects the 2D image (L), it (11) is coupled to the left fourth reflector (14); the left second reflector (12) is joined to the left third reflector (13). The left second reflector (12) again reflects the reflection image that is reflected by the left first reflector (11).

The left third reflector (13) is joined to the right side of the left-glasses frame (55). The left third reflector (13) again reflects the reflection image that is reflected by the left second reflector (12).

The left fourth reflector (14) is joined to the left side of the left-glasses frame (55). The left fourth reflector (14), into the left eye (19), reflects the reflection image that is reflected by the left third reflector (13).

The right first reflector (15) that reflects the 2D image (L), it (15) is coupled to the right fourth reflector (14); the right second reflector (16) is joined to the right third reflector (17). The right second reflector (16) again reflects the reflection image that is reflected by the right first reflector (15).

The right third reflector (17) is joined to the left side of the right-glasses frame (66). The right third reflector (17) again reflects the reflection image that is reflected by the right second reflector (16).

The right fourth reflector (18) is joined to the right side of the right-glasses frame (66). The right fourth reflector (18), into the right eye (20), reflects the reflection image that is reflected by the right third reflector (17).

Wherein the different image incident lights (L1/L2) on the left and right eyes (19, 20) are composed into 3D image in the brain, which allows distinctively to form a three-dimensional image (3D) to be watched with the 3D image that is achieved by means of a stereoscopic glasses (200).

The left first reflector (11) and the left second reflector (12) of the left-glasses frame (55), also the right first reflector (15) and the right second reflector (16) of the right-glasses frame (66) can be placed side by side to each other.

And, the left third reflector (13) and the left fourth reflector (14) of the left-glasses frame (55), also the right third reflector (17) and the right fourth reflector (18) of the right-glasses frame (66) can be placed side by side to each other.

By a connecting portion (C), the left second reflector (12) and the left third reflector (13) of the left-glasses frame (55) can be connected to the right second reflector (16) and the right third reflector (17) of the right-glasses frame (66) each other.

The effect of the stereoscopic effect is increased in accordance with the embodiment of 3D glasses (200), as the reflectors of the embodiment of 3D glasses (200) are added than the first embodiment.

According to the embodiment of the 3D eyeglasses (200).

The 2D image (L) is an incident to the left eye (19) through the loll first reflector (11), left second reflector (12), the left third reflector (13) and the left fourth reflector (14).

Also, the 2D image (L) is an incident to the right eye (20) through the right first reflector (15), the right second reflector (16), the right third ref reflector (17) and the right fourth reflector (18).

The left reflectors (11,12,13,14) and right reflectors (15,16,17,18) may be connected to each other by the left glasses frames (55), the right glasses frame (66) and glasses nose pendant (22) of 3D glasses (200).

The left glasses frame (55) and the right glasses frame (66) is connected by a glasses nose pendant (22). And the left glasses frame (55) and the right glasses frame (66) have the legs of the glasses (99).

Like FIG. 2, while 2D image (L) is undergoing process of doubled more the left reflector (11,12,13,14) and the right reflector (15,16,17,18) than reflectors of FIG. 1, the data values of the image reflected by the left reflector (11, 12, 13, 14) and the right reflector (15,16,17,18) have even more change than the data values of the first 2D image that was initial incident light.

Therefore compared to the initial incidence 2D image (L), the 2D image (L) arriving on the left/right eye (19, 20) have more parallax than the first data value of 2D image (L).

Therefore, the image that is incident to the left/right eye (19, 20), having more large parallax is formed more three-dimensional in the brain.

In particular, 3D glasses (200) of this embodiment, not only let 2D image (L) to be seen as a three-dimensional image, but also provides even more three-dimensional view of object by the stereoscopic glasses (200) than when you see object with the naked eye.

Therefore, it is possible to perform a variety for medical surgery or military.

According to the present invention, when wearing stereoscopic glasses (200), the general 2D image (L) can be viewed as a 3D image, and 3D glasses (200) can be used for all images in industrial sector.

Not only image, but also, object can be viewed in a more three-dimensional view, than object can be seen with the naked eye, when you wear three-dimensional glasses (200) according, to the present invention.

Therefore 3D glasses (200) can be used industrially in even many fields, including medical surgery.

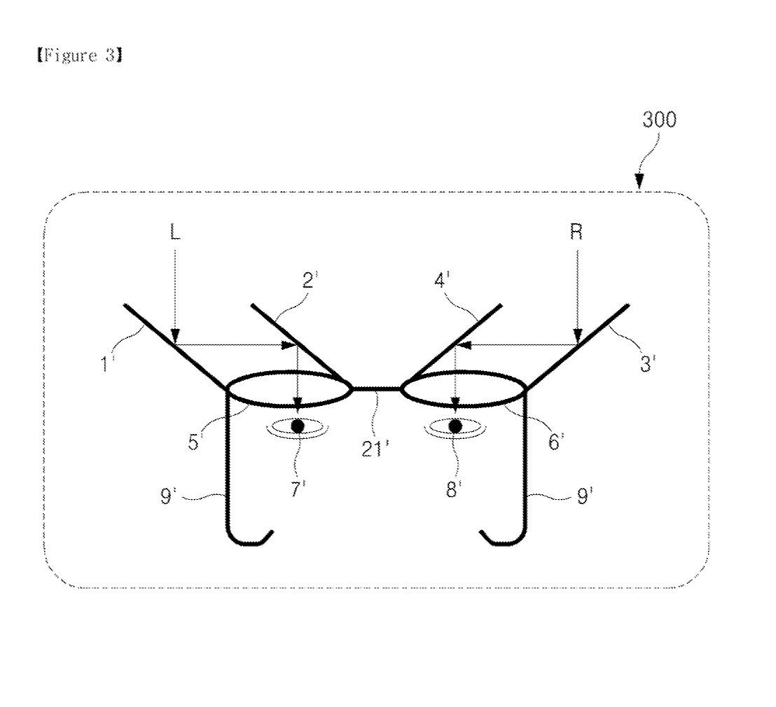

FIG. 3 is a structural diagram of a stereoscopic 3D glasses, which enable objects to be seen as a 3D image enhanced in accordance with a third embodiment of the present invention.

FIG. 3 shows a three-dimensional glasses (300), to which the reflector (1′, 2′, 3′, 4′) that enable objects or an image (L, R) to be seen as more enhanced 3D image, is attached.

Here is the embodiment.

The objects image (L) is incident on the left eye (07′) through the left first reflector (1′) of dimensional glasses (300), through the left second reflectors (2′), and then through left glasses frame (5′).

The objects image (R) is incident on the right eye (8′) through the right first mirror (3′) of dimensional glasses (300), through the right second reflector (4′) and then through the right glasses frame (6′).

The objects image (L) that is incident to the left eye (7′) has an angle of incidence that enters through the left first reflector (1′) and the left second reflector (2′).

And, the objects image (R) that is incident to the right eye (8′) has an angle of incidence that enters through the right first reflector (3′) and the right second reflector (4′).

Therefore, the incident angles of the objects image (L, R) that is incident at the left/right eye (7′, 8′) becomes wider than when you see objects image with naked eye, and becomes different from each other.

And then the wider different incident angles of the objects image (L, R) that is incident at the left/right eye (7′, 8′), are composed in the brain, to form a better three-dimensional image (3D) to have a more three-dimensional depth.

That is, the left eye (07′) watches an object image (L) through the left first reflector (1′) and the left second reflector (2′). And the right eye (8′) watches an object image (R) through the right first reflector (3) and the right second reflector (04′).

Because the paths of the objects images (L, R) entering into the left/right eye (7′, 8′) are different, the left/right, image (L, R) having, a wider parallax is generated with each better incident angle on the course of arriving at reflector, in the process of being incident on the left/right eye (7, 8′).

Therefore, through the 3D glasses (300) of the present invention, the two right and left images having a more large incident angle parallax than seeing with the naked eye, is formed with a more deep three-dimensional (3D) image by being combined in the brain after the going into the left and right eyes.

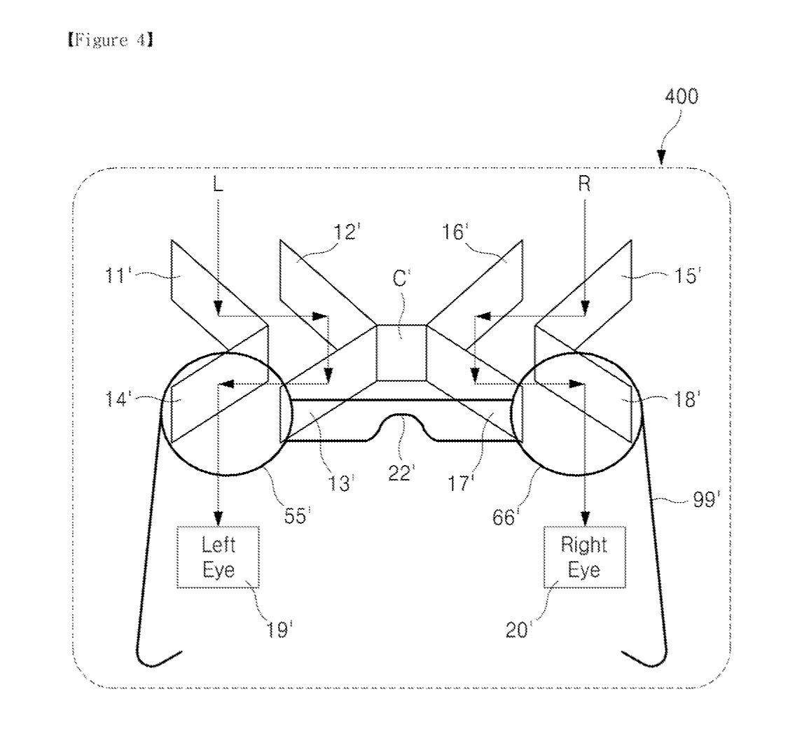

FIG. 4 is a structural diagram of stereoscopic 3D glasses to see an objects image into 3D image in accordance with a fourth embodiment of the present invention.

To watch objects image (L, R) with more deep three-dimensional image, FIG. 4 shows 3D eyeglasses (400) that the left reflectors 11′, 12′, 13′, 14′) and the right reflector (15′, 16′, 17′, 18′) are attached.

Let's look into embodiment.

The objects image (L) comes as incident light into the left eye (19′), through the left first reflector (11′), the left second reflector (12′), the left third reflector (13′) and the left fourth reflector (14′).

And, the objects image (R) comes as incident light into the right eye (20′), through the right first reflector (15′), the right second reflector (16′), the right third reflector (17′) and the right fourth reflector (18′).

The left reflectors (11′, 12′, 13′, 14′) and the right reflectors (15′, 16′, 17′, 18′) are connected to each other by the nose pad (22′) of the three-dimensional glasses (400) which is placed on the nose of the person.

Like FIG. 4, while objects image (L,R) is undergoing process of doubled more the left reflector (11′,12′,13′,14′) and the right reflector (15′,16′,17′,18′) than reflectors of FIG. 3, the data values of the image reflected by the left reflector (11′, 12′, 13′, 14′) and the right reflector (15′,16′,17°,18′) have even more parallax than the data values of the first objects image that was initial incident light.

Therefore compared to the initial incidence objects image (L, R), the objects image (L, R) arriving on the left/right eye (19′, 20′) have more parallax than the first data value of objects image (L, R)

Therefore, the image that is incident, to the left right eye (19′, 20′), having larger parallax is formed better three-dimensional image in the brain.

Although the various embodiments described above with reference to the drawings, the present invention is not limited thereto.

The form to hang the legs (9, 9′, 99, 99′) of the abovementioned three-dimensional glasses (100,200,300,400), and the shape of the three-dimensional glasses (100,200,300,400) to hang nose pad (21, 21′, 22, 22′) of the three-dimensional glasses (100,200,300,400) on the wearer's nose can be provided in various forms for carrying out the contents of the present invention.

Also, because the number of reflectors shown in the present invention is an embodiment, the better three-dimensional image can be made by increasing the number of the reflecting mirror in accordance with the principles of the invention.

Because a general 2D image can be viewed as a 3D image when wearing stereoscopic glasses of the invention, 3D glasses of present invention can be used industrially for the any video sector.

In addition to the video, when wears stereoscopic glasses according to the invention, the objects can be viewed in a more three-dimensional than can be seen with the naked eye. Therefore, 3D glasses of present invention can be used industrially in many fields, including medical surgery.

The present invention as described above is not limited to the embodiments described. So, without departing from the spirit and scope of the invention, the various modifications and variations will be evident to those skilled in the art of this technique.

Therefore, such a modification or variation examples should be among the claims of the present invention.

### DESCRIPTION OF SYMBOLS

100, 200, 300, 400; Stereoscopic glasses
1,2,3,4,11,12,13,14,15,16,17,18; Reflector
1′, 2′, 3′, 4′, 11′, 12′, 13′, 14′, 15′, 16′, 17′, 18′; Reflector
7, 19, 7′, 19′; the left eye
8, 20, 8′, 20′; The Right eye
5, 6, 5′, 6′, 55, 66, 55′, 66′; Glasses frame
9, 9′, 99, 99′; legs of glasses
21, 21′, 22, 22′; Glasses nose pads

1. A three-dimensional glasses (100) making 2D image (L) to be seen into 3D image, comprising:
a left first reflector (1) that is coupled to a left side of a left glasses frame (5), reflecting 2D image (1);
a left second reflector (2) that is coupled to a right side of the left glasses frame (5), reflecting the image reflected from the first reflector (1) into a left eye (7);
a right first reflector (3) that is coupled to a right side of a right glasses frame (6), reflecting the 2D image (L); and
a right second reflector (4) that is coupled to a left side of the right glasses frame (6), reflecting the image reflected by the right first reflector (3) into a right eye (8), wherein the three-dimensional glasses (100) is characterized to form the three-dimensional image by the different images entering the left and the right eyes (7, 8) being composed in a brain.

2. The three-dimensional glasses (100) of claim 1, wherein
the left first reflector (1) and the left second reflector (2), and the right first reflector (3) and the right second reflector (4) are arranged in parallel with each other.

3. A three-dimensional glasses (200) making 2D image (L) to be seen into 3D image, comprising:
a left first reflector (11) that is coupled to a left fourth reflector (14), reflecting a 2D image (L);
a left second reflector (12) that is coupled to a left third reflector (13), reflecting the image reflected from the left first reflector (11) to the left third reflector (13);
the left third reflector (13) that is coupled to a right side of a left glasses frame (55), reflecting the image reflected from the second reflector (12) to the fourth reflector (14);
the left fourth reflector (14) that is coupled to a left side of the left glasses frame (55), reflecting the image reflected by the left third reflector (13) into a left eye (19);
a right first reflector (15) that is coupled to a right fourth reflector (18), reflecting the 2D image (L);
a right second reflector (16) that is coupled to a right third reflector (17), reflecting the image reflected from the right first reflector (15) to the right third reflector (17);
the right third reflector (17) that is coupled to a left side of the right glasses frame (66), reflecting the image reflected from the right second reflector (16) to the right fourth reflector (18); and
the right fourth reflector (18) that is coupled to a right side of the right glasses frame (66), reflecting the image reflected by the right third reflector (17) into a right eye (20), wherein
the three-dimensional glasses (200) is characterized to form the three-dimensional image by the different images entering the left/the right eye (19, 20) being composed in a brain.

4. The three-dimensional glasses (200) of claim 3, wherein the reflectors are arranged in parallel with each other, wherein
the left first reflector (11) and the left second reflector (12) of the left-glasses frame (55), also the right first reflector (15) and the right second reflector (16) of the right-glasses frame (66) are placed side by side to each other, and wherein
the left third reflector (13) and the left fourth reflector (14) of the left-glasses frame (55), also the right third reflector (17) and the right fourth reflector (18) of the right-glasses frame (66) are placed side by side to each other.

5. The three-dimensional glasses (200) of claim 3, wherein the left second reflector (12) and the left third reflector (13) of the left-glasses frame (55) are connected to the right second reflector (16) and the right third reflector (17) of the right glasses frame (66) by a connecting portion (C).

6. A three-dimensional glasses (300) making object images (L, R) to be seen with a 3D image enhanced more than when viewed with a naked eye, comprising:
a left first reflector (1′) that is coupled to a left side of a left glasses frame (5′), reflecting the object image (L);
a left second reflector (2′) that is coupled to a right side of the left glasses frame (5′), reflecting the image reflected from the first reflector (1′) into a left eye (7′);
a right first reflector (3′) that is coupled to a right side of a right glasses frame (6′), reflecting the object image (R); and
a right second reflector (4′) that is coupled to a left side of the right glasses frame (6′), reflecting the image reflected by the right first reflector (3′) into a right eye (8′), wherein the three-dimensional glasses (300) is characterized to form the three-dimensional image by the different images entering the left/right eyes (7′, 8′) being composed in a brain, 3D glasses (300) making the object images (L, R) to be seen into 3D image enhanced more.

7. A three-dimensional glasses (400) making object images (L, R) to be seen with a 3D image enhanced more than when viewed with a naked eye, comprising:
a left first reflector (11′) that is coupled to a left fourth reflector (14′), reflecting the object image (L);
a left second reflector (12′) that is coupled to a left third reflector (13′), reflecting the image reflected from the left first reflector (11′) to left the third reflector (13′);
the left third reflector (13′) that is coupled to a right side of a left glasses frame (55′), reflecting the image reflected from the second reflector (12′) to a fourth reflector (14′);
the left fourth reflector (14′) that is coupled to a left side of the left glasses frame (55′), reflecting the image reflected by the left third reflector (13′) into a left eye (19′);
a right first reflector (15′) that is coupled to a right fourth reflector (18′), reflecting the object image (R);
a right second reflector (16′) that is coupled to a right third reflector (17′), reflecting the image reflected from the right first reflector (15′) to the right third reflector (17′);
the right third reflector (16′) that is coupled to a left side of the right glasses frame (66′), reflecting the image reflected from the right second reflector (16′) to the right fourth reflector (18′); and
the right fourth reflector (18′) that is coupled to a right side of the right glasses frame (66′), reflecting the image reflected by the right third reflector (17′) into a right eye (20′), wherein the three-dimensional glasses (400) is characterized to form the three-dimensional image by the different images entering the left/the right eyes (19′, 20′) being composed in a brain, 3D glasses (400) making the objects images (L, R) to be seen into 3D image enhanced more.

8. The three-dimensional glasses (100) of claim 1, wherein the reflector is a prism.

9. The three-dimensional glasses (200) of claim 3, wherein the reflector is a prism.

10. The three-dimensional glasses (300) of claim 6, wherein the reflector is a prism.

11. The three-dimensional glasses (400) of claim 7, wherein the reflector is a prism.

12. The three-dimensional glasses (100) of claim 1, wherein a filter or a lens is mounted in front of the reflector.

13. The three-dimensional glasses (200) of claim 3, wherein a filter or a lens is mounted in front of the reflector.

14. The three-dimensional glasses (300) of claim 6, wherein a filter or a lens is mounted in front of the reflector.

15. The three-dimensional glasses (400) of claim 7, wherein a filter or a lens is mounted in front of the reflector.
